(19) United States
(12) Patent Application Publication
(10) Pub. No.: US 2026/0251258 A1
(43) Pub. Date: Aug. 27, 2026

(54) Low Profile Magnetic Stand

(71) Applicant: Black Jet Innovations, Inc., Concord, MA (US)

(72) Inventors: Jacob Epstein, Concord, MA (US); Lukas Scheurer, Providence, RI (US)

(21) Appl. No.: 19/548,856

(22) Filed: Feb. 24, 2026

Related U.S. Application Data
(60) Provisional application No. 63/762,319, filed on Feb. 24, 2025.

(51) Int. Cl. F16M 11/04; F16M 11/10; F16M 11/38; H02J 50/10; H02J 50/90

(52) U.S. Cl. CPC F16M 11/041; F16M 11/10; F16M 11/38; H02J 50/10; H02J 50/90

(57) ABSTRACT

An expandable stand for use with a mobile device is configured to transition between a collapsed position and an expanded position. The stand includes a weighted base having a base weight and a base thickness. The weighted base further includes a base channel formed therein. An arm is pivotably coupled to the weighted base. The arm is configured such that, in the collapsed position, at least a portion of the arm is received within the base channel. A top is pivotably coupled to a second end of the arm. The top includes a magnetic coupling portion configured to magnetically couple with a magnetic attachment structure of a mobile device.

### PRIORITY

This patent application claims priority from provisional U.S. patent application No. 63/762,319, filed Feb. 24, 2025, entitled, “Expandable Magnetic Stand,” and naming Jacob Epstein as inventor, the disclosure of which is incorporated herein, in its entirety, by reference.

### FIELD OF THE INVENTION

Illustrative embodiments generally relate to devices designed to add physical functionality to mobile phones and, more particularly, illustrative embodiments relate to a device to allow users to stand their phone up in any orientation.

### BACKGROUND

Many people use their smartphones for hours every day for work and entertainment. In order to make watching or monitoring a phone screen more convenient, mobile accessory makers have invented a wide variety of phone stands to hold your phone up in different orientations.

### SUMMARY

In accordance with an embodiment, an expandable stand for use with a mobile device is configured to transition between a collapsed position and an expanded position. The stand includes a weighted base having a base weight and a base thickness. The weighted base further includes a base channel formed therein. An arm is pivotably coupled to the weighted base. The arm is configured such that, in the collapsed position, at least a portion of the arm is received within the base channel. A top is pivotably coupled to a second end of the arm. The top includes a magnetic coupling portion configured to magnetically couple with a magnetic attachment structure of a mobile device.

In various embodiments, the base weight is selected to be sufficiently high such that the expandable stand remains upright in the expanded position when the top is magnetically coupled to a mobile device. A bottom surface of the base may further include an adhesive material configured to couple the base to a support surface. The adhesive material may be reusable, pressure-sensitive, micro-suction based, or otherwise configured to provide temporary or semi-permanent attachment.

In some embodiments, the top includes a top channel configured to receive at least a portion of the arm when the expandable stand is in the collapsed position. In various embodiments, the arm has an arm thickness and the top has a top thickness, and the expandable stand has a total stand thickness in the collapsed position that is less than the cumulative thickness of the base, the arm, and the top. The nesting of the arm relative to the base and/or the top reduces the overall thickness in the collapsed configuration compared to a simple stacking of the individual component thicknesses. In certain implementations, the total stand thickness in the collapsed position is less than approximately seventy-five percent of the cumulative thickness of the base, the arm, and the top, although other ratios may be used depending on hinge thickness and the degree of nesting achieved.

In some embodiments, the top defines an opening extending through at least a portion of the top. The opening may extend fully through the top or may extend partially through the top as a recess. At least a portion of the arm may be received within the opening when the expandable stand is in the collapsed position. In certain embodiments, a protruding weight extending from the base is configured to extend into the opening in the collapsed configuration.

Magnetic segments may be arranged around at least a portion of a perimeter of the opening. The magnetic segments may be positioned circumferentially or partially circumferentially around a central region of the top to align with a magnetic attachment structure of a mobile device.

In various embodiments, the expandable stand further includes a charging module having a protruding portion configured to be received within the opening. The charging module may be magnetically retained within the opening. The protruding portion may position a charging coil closer to a mobile device magnetically coupled to the top, thereby improving charging alignment or efficiency. In other embodiments, a wireless charging coil may be disposed at least partially within the opening defined by the top, and the opening may position the wireless charging coil in alignment with the magnetic attachment structure of the mobile device to facilitate proper positioning of the device relative to the charging coil.

In accordance with another embodiment, a low-profile magnetic grip supports a mobile device. The magnetic grip includes a top having a front surface configured to couple to a mobile device. The top includes at least one magnetic segment arranged to magnetically couple to the mobile device. The top further includes a thinned region positioned outside of the magnetic segment. A bottom is spaced from the top and includes a corresponding thinned region. An arm extends between the top and the bottom and is movable between an expanded configuration and a collapsed configuration. In the collapsed configuration, at least a portion of the arm is received within a channel defined by at least one of the top or the bottom such that the arm rests within the channel and the overall thickness of the magnetic grip is minimized.

In some embodiments, the magnetic grip further includes a weight coupled to the bottom and configured to improve stability of the magnetic grip when in the expanded configuration. In certain implementations, the weight may extend into a void region of the top in the collapsed configuration.

In various embodiments, when in the collapsed configuration, portions of the top, the bottom, and the arm are arranged such that they at least partially overlap along a thickness direction to reduce the overall thickness of the magnetic grip. In some implementations, the arm is at least partially nested within regions defined by the top and the bottom in the collapsed configuration.

In certain embodiments, the thinned region of at least one of the top or the bottom defines a recess configured to receive at least a portion of the arm in the collapsed configuration. The thinned regions of the top and the bottom may be configured such that, when the arm is received within the channel in the collapsed configuration, the overall thickness of the magnetic grip is not greater than a combined thickness of the top and the bottom exclusive of the arm. In some embodiments, the thinned regions are positioned outside of the magnetic segments to create a reduced-thickness region configured to accommodate the arm while maintaining magnetic coupling strength in the magnetic segments.

In accordance with yet another embodiment, a method supports a mobile device by coupling a top of a stand to a mobile device using a magnetic coupling structure. The stand is transitioned from a collapsed configuration to an expanded configuration by moving an arm structure relative to a base and the top. The mobile device is positioned in a viewing orientation while the arm structure supports the top relative to the base. The stand, while coupled with the mobile device, is stabilized on a support surface using a weight of the base and/or a weight coupled to the base.

The transition between the collapsed and expanded configurations may be accomplished in various ways. In some embodiments, transitioning the stand comprises pivoting the arm structure relative to the base and the top. In other embodiments, transitioning comprises extending or retracting a telescoping portion of the arm structure. In the collapsed configuration, at least a portion of the arm structure may be received within a recess of the base and/or the top. Transitioning to the collapsed configuration may include arranging the base, arm structure, and top such that they at least partially overlap along a thickness direction, and in some embodiments, components of the stand may interleave or interdigitate to reduce overall thickness.

Stabilization of the stand may be achieved in multiple ways. In certain embodiments, stabilizing the stand includes providing a weight coupled to the base. The weight may extend into a void region of the top in the collapsed configuration. The weight may be centrally located, peripherally located, annular, segmented, or distributed across multiple regions of the base. In addition to or instead of weight-based stabilization, stabilizing the stand may include engaging a friction-enhancing surface on the base with the support surface, deploying one or more stabilizing extensions from the base, or clamping the base to a structure.

In some embodiments, the method further includes providing electrical functionality. The mobile device may be wirelessly charged using a charging coil positioned within the top and/or the base. Electrical conductors may be positioned within the arm structure to route power or signals between components. In certain implementations, a removable charging pad may be magnetically attached to the top. In other embodiments, the mobile device may be powered using electrical contacts positioned between the top and the mobile device.

In accordance with another embodiment, a collapsible stand system for supporting a mobile device includes a base having a base thickness and a base recess, and a top having a top thickness and a top recess. An arm is pivotally coupled between the base and the top. At least one weight is coupled to the base. In a collapsed configuration, the arm is received within at least one of the base recess and the top recess. In the collapsed configuration, the weight extends from the base into an interior region of the top. Due to this structural arrangement, the overall thickness of the stand in the collapsed configuration does not exceed a combined thickness of the base and the top.

In some embodiments, the top includes a plurality of magnetic segments configured to magnetically couple to a magnetic attachment structure of a mobile device. The magnetic segments may be arranged circumferentially around a central region of the top. In certain implementations, the top recess is disposed within the central region. In some embodiments, the magnetic segments comprise permanent magnets polarized to align with a MagSafe or Qi2 magnetic ring or similar magnetic attachment structure. In certain embodiments, the collapsible stand system further includes the mobile device magnetically coupled to the top.

In accordance with another embodiment, a collapsible mobile device stand includes a base, a top configured to support a mobile device, and an arm structure extending between the base and the top and movable between expanded and collapsed configurations. In the collapsed configuration, at least a portion of the arm structure is received within an internal channel defined by at least one of the base or the top. The stand has a maximum device thickness in the collapsed configuration that is less than a sum of a base thickness, an arm thickness, and a top thickness measured independently, thereby reflecting the structural nesting of the components rather than a simple stacked arrangement.

In certain implementations, the maximum device thickness in the collapsed configuration is defined by the greater of (i) a combined thickness of the base, the arm structure, and the top as arranged in the collapsed configuration, or (ii) a maximum external thickness defined by a hinge or other protruding structural element of the stand.

In various embodiments, the base thickness includes thickness contributed by a weight coupled to or embedded within the base. The weight may be integrated within an external thickness envelope of the base in the collapsed configuration. The top thickness may include thickness contributed by one or more magnetic elements embedded within, attached to, or overmolded by the top. The top thickness may also include thickness contributed by a wireless charging coil positioned within the top. Similarly, the base thickness may include thickness contributed by an electrical component positioned within the base. The arm thickness may include thickness contributed by an internal electrical conductor, structural reinforcement, or hinge interface.

In some embodiments, at least one of the base or the top includes an overmolded layer, coating, surface treatment, adhesive layer, pad, or attachment structure that contributes to the respective component thickness. In such embodiments, these additional elements are considered part of the external thickness of the respective component in the collapsed configuration.

In accordance with a further embodiment, a collapsible magnetic stand for supporting a mobile device includes a base, a top configured to magnetically couple to a mobile device, and an arm extending between the base and the top. The arm is movable between an expanded configuration and a collapsed configuration. The top includes a recess extending into a thickness of the top. The top further includes a plurality of magnetic segments arranged in a non-continuous configuration. The non-continuous configuration of magnetic segments defines a magnet-free region within the top corresponding to the recess. In the collapsed configuration, at least a portion of the arm is received within the recess such that the arm is positioned within a thickness envelope of the top.

In some embodiments, in the collapsed configuration, an overall thickness of the stand is less than a sum of a base thickness, an arm thickness, and a top thickness measured independently, reflecting the structural nesting of the arm within the top rather than a simple stacked arrangement of the components.

The magnetic segments may be arranged in various configurations. In certain embodiments, the magnetic segments are arranged along an arc that spans less than 360 degrees around the recess. In other embodiments, the magnetic segments are positioned around at least a portion of the recess and may be separated by gaps. The recess may be centrally located relative to the magnetic segments, although other positional relationships are contemplated. In some implementations, the magnetic segments are arranged such that the recess is located within a region of the top that is free of magnetic material, and the recess may extend into that magnet-free region. In certain embodiments, the magnetic segments are configured to at least partially align with a MagSafe or Qi2 magnetic attachment structure or other compatible magnetic coupling arrangement.

### BRIEF DESCRIPTION OF THE DRAWINGS

The advantages of the embodiments described herein, together with further advantages, may be better understood by referring to the following description taken in conjunction with the accompanying drawings. The drawings are not necessarily to scale; emphasis is instead generally being placed upon illustrating the principles of the various embodiments.

The Expandable Magnetic Stand is herein referred to as the “Expandable Stand”.

FIG. 1A is a side-rear perspective view of the Expandable Stand in the expanded position in accordance with illustrative embodiments.

FIG. 1B is a side-rear perspective view of another embodiment of the Expandable Stand in the expanded position in accordance with illustrative embodiments.

FIG. 2 is a side-front perspective view of the Expandable Stand in the expanded position in accordance with illustrative embodiments.

FIG. 3A is a cutoff side perspective view of the Expandable Stand in the collapsed position in accordance with illustrative embodiments.

FIG. 3B is a cross-sectional view of the Expandable Stand transitioning between the collapsed position and the expanded position in accordance with illustrative embodiments.

FIG. 3C is a cross-sectional view of the Expandable Stand in the collapsed position in accordance with illustrative embodiments.

FIG. 4 is a side view of the Expandable Stand in the collapsed position in accordance with illustrative embodiments.

FIG. 5 is a view of a mobile device and its integrated magnetic attachment ring in accordance with illustrative embodiments.

FIG. 6 is a view of the Expandable Stand Top with a cutoff view of a mobile device and integrated magnetic attachment ring overlaid in accordance with illustrative embodiments.

FIG. 7 is a side view of the Expandable Stand in the expanded state with an attached mobile device in accordance with illustrative embodiments.

FIG. 8 is a top view of the Expandable Stand in the collapsed state in accordance with illustrative embodiments.

FIG. 9 is a side view of the Expandable Stand in an airplane seat back tray table in accordance with illustrative embodiments.

FIG. 10 is a side view of the Expandable Stand with a charging pad on the top in accordance with illustrative embodiments.

FIGS. 11A and 11B are a side and top view of a shaped charger in accordance with illustrative embodiments.

FIG. 12 is a side view of the Expandable Stand with a shaped charger magnetically stuck to the back in accordance with illustrative embodiments.

FIG. 13 is a perspective view of the Expandable Stand with an integrated charging coil in accordance with illustrative embodiments.

FIG. 14 shows a process of using the Expandable Stand in accordance with illustrative embodiments.

### DETAILED DESCRIPTION

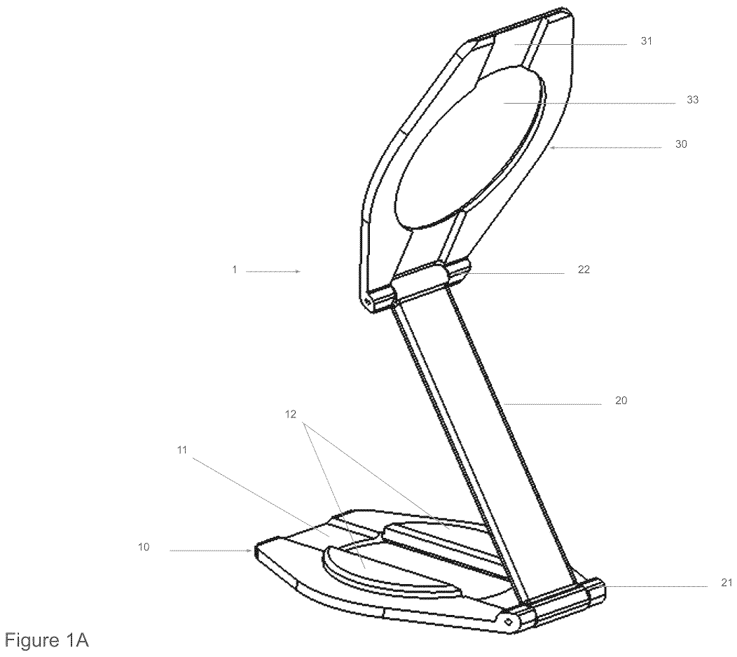

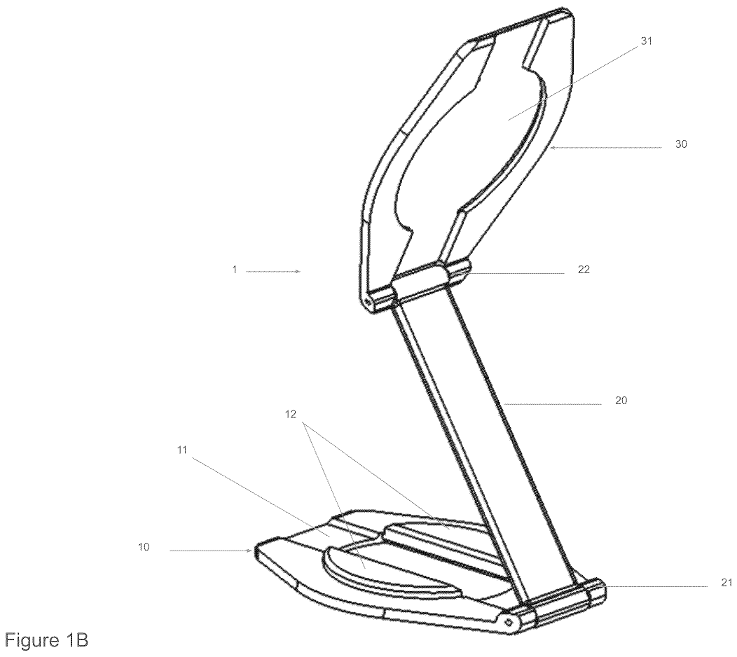

FIG. 1A shows a side-rear perspective view of the Expandable Stand 1 in the expanded position in accordance with illustrative embodiments. In various embodiments, the Expandable Stand 1 is a self-contained mobile accessory which attaches to a mobile device to provide a stable stand-function so that a user can view their screen in different orientations without using their hands.

To make watching or monitoring a phone screen more convenient, illustrative embodiments provide a phone stand 1 that is configured to collapse to a very small thickness for transportation. Illustrative embodiments advantageously provide the phone stand 1 having a stable center of gravity so that the phone/mobile device does not tip the stand over easily when coupled with the stand 1. The Expandable Stand 1 can be collapsed to a very small profile so it can be easily transported in a pocket, bag, etc.

FIG. 1A shows the Expandable Stand 1 in the expanded position from a rear perspective view. As shown in FIG. 1A, in various embodiments, the Expandable Stand 1 includes three main sections.

A Base 10 is near the bottom of the Expandable Stand 1 in the expanded position (also referred to as a deployed position). The Base 10 may have one or more Projected Weights 12 which add weight to the Base 10 but project upward through the entire assembly when in the collapsed position. The Base 10 also has a Base Hinge 21 on which a Center Arm 20 pivots. The Base 10 also has a Base Channel 11 that is configured to receive at least a portion of the Center Arm 20 when transitioned to the collapsed position.

As used herein, the terms “collapsed configuration” and “expanded configuration” refer to general structural states of the device rather than to a single discrete angular or positional arrangement. The expanded configuration includes a range of relative angular orientations between the base, arm, and top that permit viewing of a mobile device. The collapsed configuration includes relative orientations in which the arm is received within the base and/or top such that the overall thickness of the assembly is minimized.

The Top 30 includes the Top Hinge 22 as well as a Top Channel 31 which is configured to receive at least a portion of the Center Arm 20 in the collapsed position. In some embodiments, the Top Channel 31 may formed of or include a Passage 33 (e.g., additionally, or alternative to, a recessed portion). As shown in FIG. 1B, some embodiments may not have the passage 33. Instead, the top channel 31 may be shaped to receive the added weights 12 (e.g., by having a corresponding shape configured to receive the added weights 12).

The Top 30 may define an opening positioned in a central region; however, the opening is not limited to a centrally located, circular through-hole. The Top 30 may define one or more openings that are centrally located, offset, or distributed across the Top 30. The opening may be circular, oval, polygonal, slot-shaped, or otherwise contoured, and may be fully enclosed or partially enclosed by surrounding material of the Top 30. In certain embodiments, the opening may extend fully through the Top 30, while in other embodiments the opening may comprise a blind recess that extends only partially through the thickness of the Top 30. The opening may be configured in any geometry that permits reception of at least a portion of the Arm 20 and/or Projected Weight 12 in the collapsed configuration while maintaining a minimized overall thickness of the Expandable Stand 1.

The Arm 20 suspends the Top 30 away from the Base 10 in the expanded position. The Arm 20 pivots on the Base Hinge 21 and a Top Hinge 22, such that the Top 30 may be at a variety of height distances and angles relative to the Base 10.

The Arm 20 is shown as a single rigid member pivotally coupled between the Base 10 and the Top 30. However, the Arm 20 may take many different structural forms so long as it enables relative movement between the Base 10 and the Top 30 and permits nesting within the Expandable Stand 1 in the collapsed configuration. The Arm 20 may comprise one or more structural members and may be rigid, semi-rigid, flexible, articulated, telescoping, integrally formed, or otherwise movable relative to the Base 10 and the Top 30.

In certain embodiments, the Arm 20 may comprise multiple interconnected members rather than a single member. For example, the Arm 20 may include two or more links connected by one or more intermediate hinge mechanisms, such as additional pivot joints positioned between the Base Hinge 21 and the Top Hinge 22. The Arm 20 may be configured as a scissor-style linkage, a folding linkage, or another articulated structure having multiple pivot points. In such embodiments, the multiple members of the Arm 20 may fold relative to one another in the collapsed configuration so as to reduce overall thickness. The members may interleave, overlap, or stack within the Base Channel 11 and/or the Top Channel 31 when the Expandable Stand 1 is in the collapsed configuration. These articulated embodiments may provide a broader range of expanded configurations while preserving the ability to nest within the volume defined by the Base 10 and the Top 30.

In some embodiments, the Arm 20 may include a telescoping structure. For example, the Arm 20 may comprise a sliding inner member received within an outer member, a nested tubular arrangement, a rail-and-slider mechanism, or another guided linear extension mechanism. The Arm 20 may collapse by sliding inward to reduce its effective length and may extend in the expanded configuration to increase the spacing between the Base 10 and the Top 30. A telescoping structure may be used alone or in combination with one or more pivot joints such as the Base Hinge 21 and the Top Hinge 22.

In various embodiments, the Arm 20 may be partially or entirely flexible. For example, the Arm 20 may comprise a spring steel strip, an elastomeric member, or a bendable metal core encased within a polymer material. The Arm 20 may be manually shaped into a desired configuration and may maintain that configuration through inherent material stiffness or elastic resistance. A flexible Arm 20 may eliminate the need for discrete hinge components while still permitting transition between the collapsed configuration and the expanded configuration.

In other embodiments, the Arm 20 may incorporate one or more multi-axis articulation mechanisms. For example, the Arm 20 may include a spherical joint connecting the Arm 20 to the Base 10, a spherical joint connecting the Arm 20 to the Top 30, or a universal joint providing rotation about multiple axes. Such multi-axis joints may allow additional viewing orientations while still enabling the Arm 20 to be repositioned into the collapsed configuration.

In various embodiments, the Arm 20 may be formed integrally with the Base 10 and/or the Top 30 using a living hinge structure. For example, a molded polymer hinge region or a thin flexure region may permit controlled bending of the Arm 20 relative to the Base 10 or the Top 30. In such embodiments, the Arm 20 and at least one of the Base 10 or the Top 30 may be formed as a single piece while still permitting movement between the collapsed configuration and the expanded configuration.

The Arm 20 may also include alternative position-retention mechanisms. Instead of or in addition to friction provided by the Base Hinge 21 and the Top Hinge 22, the Arm 20 may incorporate a ratchet mechanism, a detent mechanism, a magnetic detent, an over-center mechanism, a spring-biased locking element, or a cam-lock structure. These mechanisms may maintain the Arm 20 in selected expanded configurations or in the collapsed configuration without requiring continuous friction torque.

In embodiments incorporating electrical functionality, the Arm 20 may include internal routing features. For example, the Arm 20 may define an internal passage for a wire, conductive traces, spring-loaded electrical contacts, flexible flat cables, or other electrical conductors extending between the Base 10 and the Top 30. Such routing may enable electrical communication or power transfer between components while preserving the collapsible structure of the Expandable Stand 1.

In some embodiments, the Arm 20 may include cutouts, recesses, or shaped profiles that interleave with portions of the Base 10 or the Top 30 in the collapsed configuration. For example, the Arm 20 may include openings configured to receive portions of the Projected Weight 12 when the Expandable Stand 1 is collapsed. The Arm 20 may be U-shaped, C-shaped, partially hollow, or otherwise contoured to enhance volumetric nesting and reduce collapsed thickness.

The Arm 20 need not be centrally positioned relative to the Base 10 and the Top 30. In certain embodiments, the Arm 20 may be laterally offset from a centerline of the Base 10 and the Top 30. In other embodiments, the Expandable Stand 1 may include multiple arms extending between the Base 10 and the Top 30. For example, two Arms 20 may be spaced apart to provide additional structural rigidity. Such multiple arms may collapse into recesses within the Base 10 and/or the Top 30 while still preserving a low-profile collapsed configuration.

Accordingly, the Arm 20 may comprise any structure configured to move the Top 30 relative to the Base 10 between the collapsed configuration and the expanded configuration. The Arm 20 may be rigid, articulated, telescoping, flexible, integrally formed, multi-membered, or otherwise movable, and may include one or more pivot joints, sliding interfaces, flexure regions, or combinations thereof.

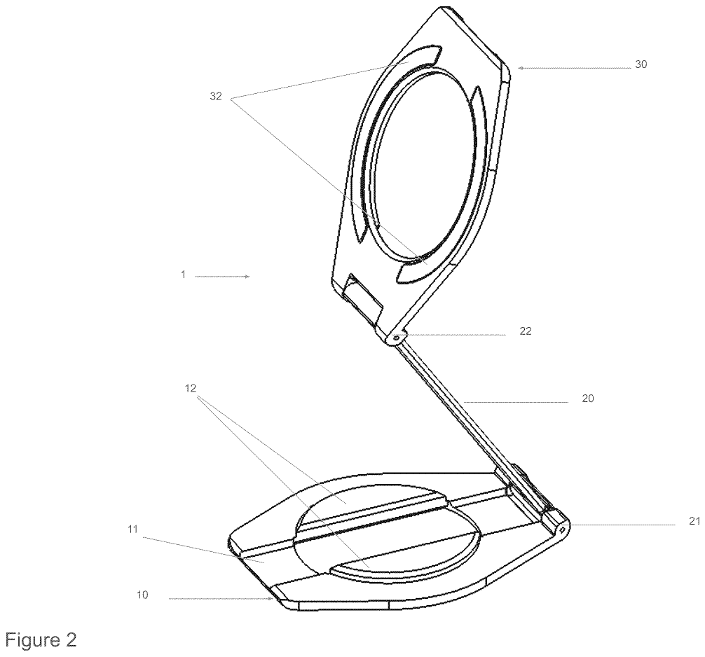

FIG. 2 is a side-front perspective view of the Expandable Stand 1 in the expanded position in accordance with illustrative embodiments. It can now be seen that on a surface (e.g., the top surface) of the Top 30 there may be one or more Magnetic Segments 32. As used herein, the term “Magnetic Segments 32” is intended to encompass a single magnetic segment as well as a plurality of discrete magnetic segments. Thus, the magnetic structure may include a single magnetic element, multiple separated magnetic elements, or any segmented magnetic configuration. The Magnetic Segments 32 are shown and described in later figures as magnetically coupling to a Mobile Device 600.

In certain embodiments, the Top 30 may include one or more magnets or magnetic elements. In other embodiments, the Top 30 may instead include ferromagnetic material configured to magnetically interact with magnets of a mobile device. In still other embodiments, the Top 30 may not include magnets or magnetic material, and the stand may couple to the mobile device using alternative attachment mechanisms.

In some embodiments, the Magnetic Segments 32 may comprise permanent magnets, magnetizable materials, ferromagnetic materials, electromagnetic elements, or combinations thereof. Accordingly, “Magnetic Segments” may refers broadly to one or more elements configured to magnetically interact with a magnetic attachment structure of a mobile device, whether by generating a magnetic field, responding to a magnetic field, or both.

Among other things, the Magnetic Segments 32 disposed within the Top 30 may comprise permanent magnets, ferromagnetic materials, or combinations thereof, and are configured to magnetically interact with a Magnetic Ring 632 associated with a Mobile Device 600. In certain embodiments, the Magnetic Segments 32 are magnetically attractive and generate a magnetic field configured to attract a magnetically attractable structure of the Mobile Device 600. In other embodiments, the Magnetic Segments 32 may themselves be magnetically attractable, such as ferromagnetic inserts, and may be attracted to magnets contained within the Magnetic Ring 632 of the Mobile Device 600. The Magnetic Segments 32 and the Magnetic Ring 632 may therefore include magnetically attractive components, magnetically attractable components, or combinations of both, such that magnetic coupling occurs when the Mobile Device 600 is brought into proximity with the Top 30. This magnetic interaction retains the Mobile Device 600 relative to the Top 30 while permitting intentional detachment when a separating force sufficient to overcome the magnetic attraction is applied.

The Base Hinge 21 and Top Hinge 22 may be any style hinge that allows the Arm 20 to pivot respectively from the Base 10 and Top 30. In various embodiments, the hinge may allow 360 degrees of motion. In various embodiments, the hinges 21, 22 may offer some type of resistance to adjustment of angle, such as a “friction hinge” style hinge 21, 22. A friction hinge allows a user to overcome a hinge threshold force to change the angle of the Arm 20 with respect to the Base 10 and/or Top 30. Thus, the relative position of the top 30 and/or the base 10 relative to the Arm 20 is held in position using an internal friction inside the hinge 21 and/or 22. Accordingly, the Expandable Stand 1 can be expanded by overcoming the threshold force, and then remains in the expanded position due to the internal friction of the hinges. In a similar manner, the Expandable Stand 1 can be collapsed by overcoming the threshold force, and remains in the collapsed position due to the internal friction of the hinges. Friction hinges 21, 22 come in a variety of designs and friction levels and are common in the industry. One skilled in the art can adjust the threshold force as desired (e.g., for the expected weight of the mobile device).

As described above, the Arm 20 is pivotally coupled to the Base 10 by the Base Hinge 21 and to the Top 30 by the Top Hinge 22, which may include frictional resistance to maintain selected orientations. However, the Base Hinge 21 and the Top Hinge 22 are not limited to friction hinges and may comprise any suitable articulation mechanism. For example, the Base Hinge 21 and/or the Top Hinge 22 may include a ratchet mechanism configured to permit incremental angular adjustment, a detent mechanism configured to retain discrete positions, or a magnetic detent structure configured to magnetically bias the Arm 20 toward selected orientations.

In some other embodiments, the Base Hinge 21 and/or the Top Hinge 22 may include a spring-biased mechanism that resists movement and maintains the Expandable Stand 1 in either the collapsed configuration or the expanded configuration. An over-center hinge configuration may be used such that the Arm 20 is biased toward stable positions at opposite ends of its range of motion. In certain embodiments, the Arm 20 may be integrally formed with the Base 10 and/or the Top 30 using a living hinge structure, such as a molded polymer flexure region, thereby permitting pivoting movement without separate hinge hardware.

Accordingly, the Base Hinge 21 and the Top Hinge 22 may comprise friction-based, ratcheting, detent-based, magnetic, spring-biased, over-center, living hinge, or other articulation mechanisms capable of permitting movement of the Arm 20 between the collapsed configuration and the expanded configuration.

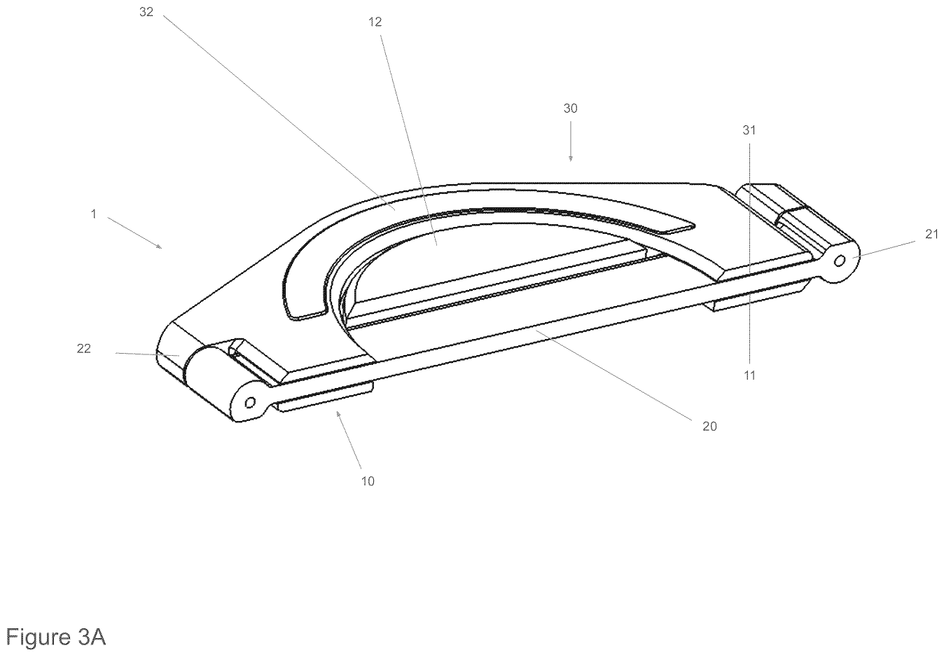

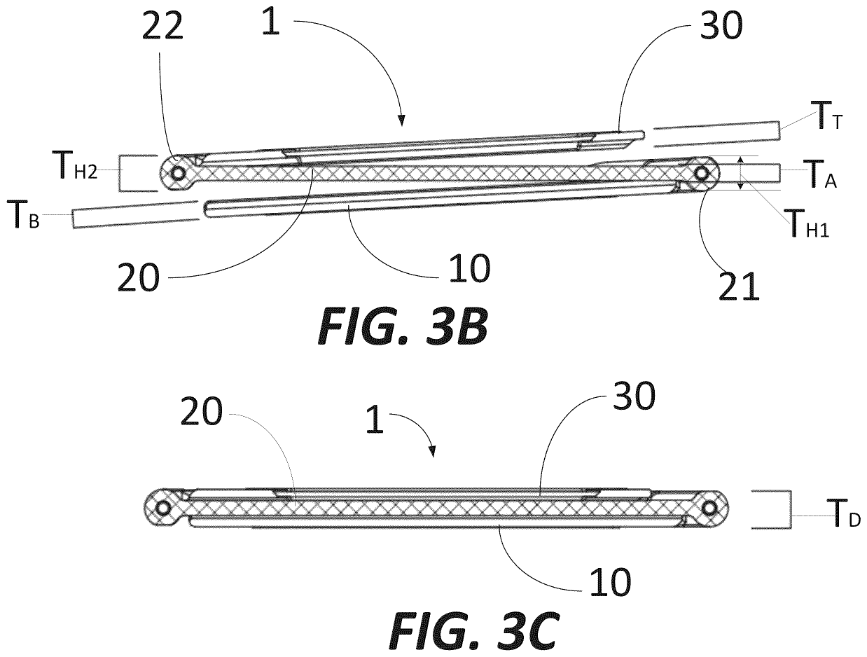

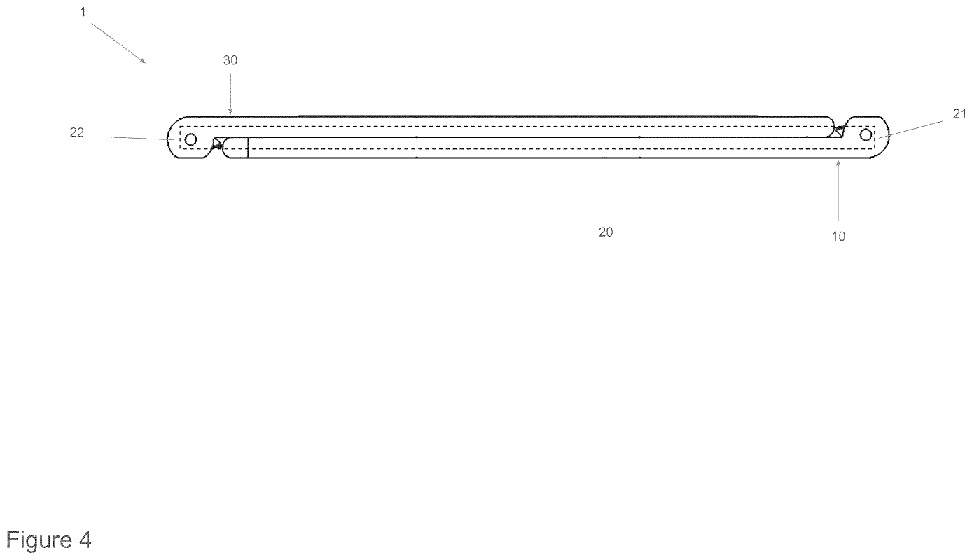

FIG. 3A is a cutoff side perspective view of the Expandable Stand 1 in the collapsed position in accordance with illustrative embodiments. Advantageously, in the collapsed position, the Arm 20 is nestled inside of the recessed Base Channel 11 and Top Channel 31. In this way, the thickness of the Arm 20 T_{A} is received within the external thickness envelope formed by the thickness of the Top T_{T} and the thickness of the Base T_{B} when in the collapsed position. In other words, from a side view, such as that shown in FIG. 4, the Arm may be completely encapsulated/hidden inside of the Top 30 and Base 10. In FIG. 4, the Arm 20 is shown as a dotted line because it is inside of the Stand 1. It can be seen that in this respect the Arm 20 has been integrated through a design that does not increase the thickness of the Expandable Stand 1 in the collapsed position (e.g., beyond the aggregate thickness of the Top 30 and Bottom 10).

FIG. 3B is a cross-sectional view of the Expandable Stand 1 transitioning between the collapsed position and the expanded position in accordance with illustrative embodiments. FIG. 3C is a cross-sectional view of the Expandable Stand 1 in the collapsed position in accordance with illustrative embodiments. Together, FIGS. 3A-3C show representative thickness dimensions of portions of the Expandable Stand 1. For purposes of description, the Base 10 has a base thickness T_{B}, the Base Hinge 21 has a hinge thickness T_{H1}, the Arm 20 has an arm thickness T_{A}, the Top Hinge 22 has a hinge thickness T_{H2}, and the Top 30 has a top thickness T_{T}.

Unless otherwise specified, the thickness of a component of various embodiments of the Expandable Stand 1 refers to the maximum external distance between opposing outer surfaces of that component measured in a direction generally perpendicular to a primary plane of the Expandable Stand 1 in the collapsed configuration. The thickness of a component may include structural material, embedded components, attached components, overmolded portions, magnets, weights, hinge structures, coatings, or other elements that contribute to the external dimension of that component. Thickness does not require a continuous solid member and may include internal voids, recesses, cavities, or air gaps. For example, the thickness of the base T_{B} may include the thickness of any weights coupled with the base 10, and/or the thickness of the top T_{T} may include magnets coupled with the top 30.

As shown in FIG. 3C, in the collapsed configuration, portions of the Base 10, the Arm 20, and the Top 30 at least partially overlap. In this manner, the Arm 20 is received within internal regions defined by the Base 10 and/or the Top 30, such that the overall external device thickness T_{D} of the Expandable Stand 1 in the collapsed configuration is less than a simple sum of T_{B}+T_{A}+T_{T}.

In various embodiments, the device thickness T_{D} is the maximum external distance between opposing outermost surfaces of the Expandable Stand 1 in the collapsed configuration. In some embodiments, T_{D} is substantially defined by overlapping portions of the Base 10 and Top 30. In other embodiments, T_{D} may be defined by the greatest external dimension of any component, including the Base 10, Arm 20, Top 30, Base Hinge 21, Top Hinge 22, or other structural elements.

In various embodiments, one or more hinge structures (e.g., Base Hinge 21 and/or Top Hinge 22) may be positioned partially or entirely outside of a primary overlapping region formed by the Base 10, Arm 20, and Top 30. In such embodiments, the device thickness T_{D} may be determined by the greater of: (i) the combined overlapping thickness of the Base 10, Arm 20, and Top 30; or (ii) the maximum thickness defined by any hinge or other protruding structural element.

The overlapping relationship among the Base 10, Arm 20, and Top 30 need not involve complete encapsulation. In various embodiments, the components may partially nest, interleave, interdigitate, or otherwise share internal volume to reduce overall thickness. Small gaps, tolerances, or non-contact regions may exist between components in the collapsed configuration without departing from the disclosed thickness relationships.

Accordingly, the collapsed device thickness TD reflects the external profile of the assembled Expandable Stand 1 in the collapsed configuration, regardless of whether individual component thicknesses are continuous, partially overlapping, or separated by void regions.

In one non-limiting example, the Base 10 may have a base thickness T_{B} of approximately 2.25 mm, the Arm 20 may have an arm thickness T_{A} of approximately 2.0 mm, and the Top 30 may have a top thickness T_{T} of approximately 2.25 mm. In certain embodiments, the Base Hinge 21 and Top Hinge 22 may each have a hinge thickness T_{H1}, T_{H2} of approximately 4.8 mm.

In the collapsed configuration illustrated in FIG. 3C, at least a portion of the Arm 20 is received within internal space defined by the Base 10 and/or the Top 30. Because of this nesting relationship, the Arm 20 does not simply stack on top of the Base 10 and the Top 30 along a thickness direction. Instead, the components are arranged such that the maximum device thickness T_{D} in the collapsed configuration is governed by the greatest external thickness of any structural element.

In the illustrative embodiment above, although T_{B}+T_{A}+T_{T} would total approximately 6.5 mm if purely stacked, the collapsed device thickness T_{D} may instead be approximately 4.8 mm, because the hinge thickness T_{H1} or T_{H2} defines the maximum external dimension of the assembled device in the collapsed configuration.

This example demonstrates that the overall collapsed thickness T_{D} may be substantially less than the arithmetic sum of the individual component thicknesses due to the nesting and internal reception of the Arm 20 within the Base 10 and/or the Top 30.

It should be understood that the foregoing dimensions are exemplary only and are not limiting. In various embodiments, the Base 10 and Top 30 may each have a thickness in a range of approximately 1.5 mm to 4.0 mm, and the Arm 20 may have a thickness in a range of approximately 1.0 mm to 3.5 mm. The hinge thickness may vary depending on hinge design, material selection, load requirements, and desired durability, and may, for example, range from approximately 3.0 mm to 6.0 mm in some embodiments.

In many practical implementations, the hinge structure may define the controlling thickness of the collapsed configuration. Accordingly, reduction in hinge thickness may directly reduce the maximum device thickness T_{D}. It is therefore contemplated that alternative hinge designs, including low-profile friction hinges, ratchet hinges, living hinges, or other compact articulation mechanisms, may enable collapsed device thicknesses less than 4.8 mm.

In some embodiments, the collapsed device thickness T_{D} may be less than approximately 5.0 mm, less than approximately 4.5 mm, less than approximately 4.0 mm, or even less depending on material selection and hinge architecture. In other embodiments, structural reinforcement, charging components, magnets, weights, coatings, or other functional elements may increase the collapsed thickness while remaining within the scope of the disclosed concepts.

Accordingly, the specific numerical thicknesses described herein are illustrative examples of one implementation and do not limit the structural relationships described, namely that the Arm 20 is received within internal regions of the Base 10 and/or Top 30 such that the maximum collapsed thickness T_{D} is not determined by a simple stacking of T_{B}+T_{A}+T_{T}.

In various embodiments, the relationship between the collapsed device thickness T_{D} and the individual component thicknesses T_{B} (base thickness), T_{A} (arm thickness), and T_{T} (top thickness) may be expressed as a ratio. In particular, the collapsed thickness T_{D} may be less than the arithmetic sum of TB+TA+TT due to the internal reception of the Arm 20 within the Base 10 and/or Top 30.

Accordingly, in some embodiments: TD<(TB+TA+TT).

In further embodiments, the ratio: TD/(TB+TA+TT) may be less than 1.0, and in some implementations may be substantially less than 1.0.

By way of non-limiting example, the ratio TD/(TB+TA+TT) may be less than approximately 0.95, less than approximately 0.90, less than approximately 0.85, or less than approximately 0.80, depending on hinge thickness and the degree of nesting between components.

These ratios are illustrative only and may vary depending on structural configuration, hinge geometry, material selection, embedded components, and other design considerations. The inventive concept resides in the structural arrangement permitting reduction of collapsed thickness relative to a simple stacking of the individual component thicknesses, rather than in any specific numerical ratio.

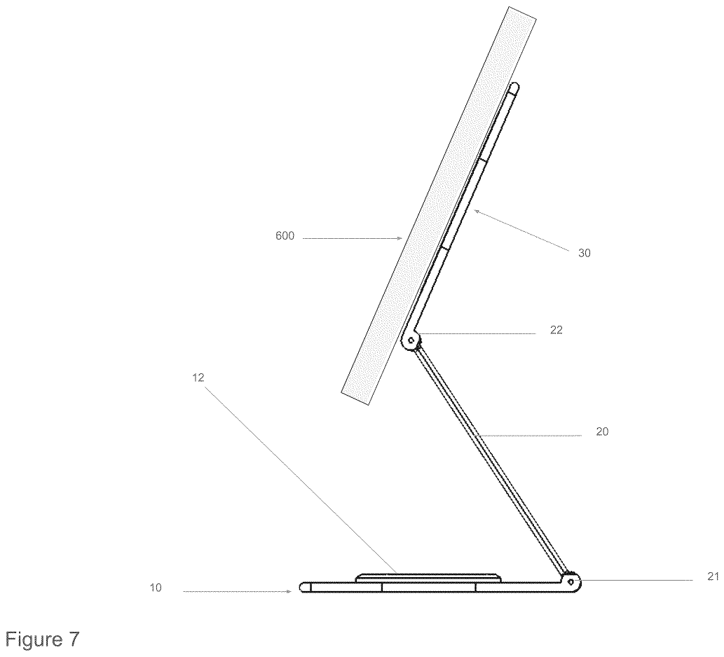

As yet another advantage, looking at FIG. 2 and FIGS. 3A-3C together, it can be seen that the Projected Weight(s) 12 add weight and thickness to the Base 30 in the expanded position, but do not add thickness to the overall Expandable Stand 1 in the collapsed position. This is because the Projected Weights 12 are attached to the Base 10 but are configured to project upward around the Arm 20 and through Passage(s) 33 in the Top 30. Illustrative embodiments advantageously fill the empty Passage in the center of the Top 30 by filling it with weight (e.g., Projected Weights 12), which may be attached to and/or formed as part of the Base 10 (collectively referred to as coupled to the base). Having this additional weight 12 coupled to the Base 10 makes the Expandable Stand 1 more stable in the expanded position and desirably does not add thickness to the Stand 1 in the collapsed position. The Projected Weight 12 in the expanded position can be further seen in FIG. 7.

In some embodiments, the Weight 12 attached to the Base 10 need not be centrally located or formed as a single upward projection. Instead, the Weight 12 may be distributed in multiple regions of the Base 10 and configured to extend into one or more void regions of the Top 30 in the collapsed configuration. For example,

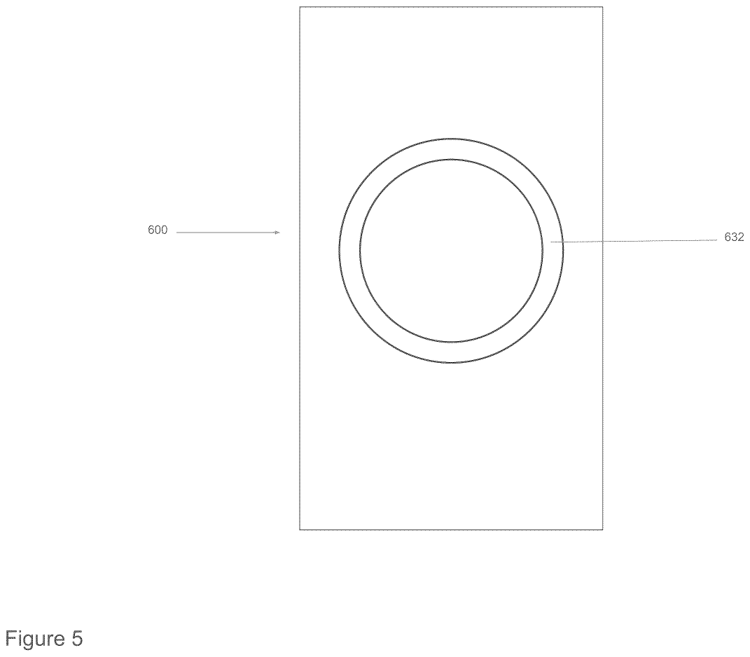

FIG. 5 is a view of a mobile device 600 having an integrated magnetic attachment ring 632 in accordance with illustrative embodiments. The Magnetic Ring 632 is used for, among other things, attaching accessories (e.g. grips, wallets, etc.) to the Mobile Device 600. This figure is shown as a reference to describe the industry standard magnetic attachment mechanisms of Apple MagSafe and Qi2, as well as other similar magnetic attachment mechanisms which are integrated into mobile devices and cases. Although FIG. 5 shows the Magnetic Ring 632 as part of the Mobile Device 600, it should be noted that these Magnetic Rings 632 are sometimes inside of the Mobile Device 600. Additionally, or alternatively, magnets (e.g., magnetic rings 623) may be integrated into cases or otherwise attached to a case or mobile device.

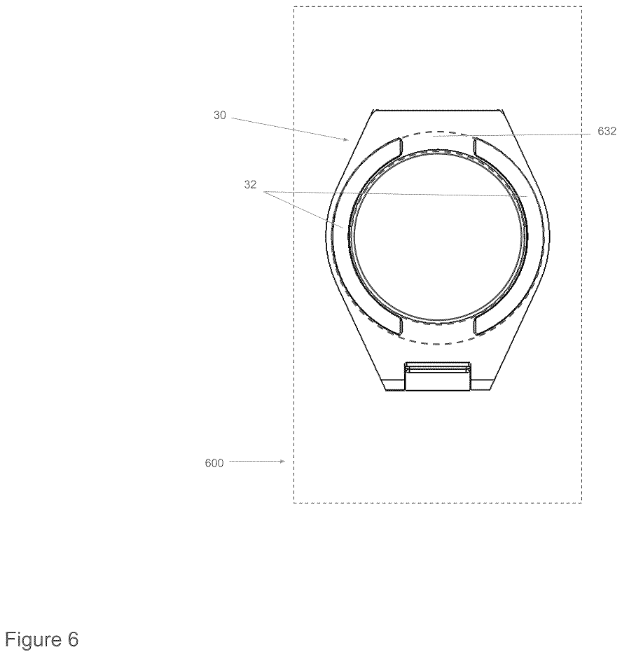

FIG. 6 shows the Mobile Device 600 overlaid in dotted line over the top of the Top 30 of the Expandable Stand. It can be seen in FIG. 6 the Magnetic Segments 32 of the Top 30 fit within the area of the Magnetic Ring 632 (also in dotted lines) of the Mobile Device 600 and therefore are attracted to and/or attractable to the Mobile Device 600. Accordingly, the Mobile Device 600 can be said to “stick” to the Expandable Stand 1 because some (or all) of its Magnetic Ring 632 is magnetically attracted to the Magnetic Segments 32 of the Top 30 of the Expandable Stand 1.

In many conventional MagSafe-compatible accessories, a complete annular magnet ring is provided within the top portion of the accessory to align with and magnetically couple to the corresponding magnetic attachment structure of the mobile device 600. Such full-ring configurations typically occupy the central radial region of the accessory and extend continuously around a central axis. Because the annular magnet ring is continuous, the magnet material and associated structural support occupy the full circumferential footprint of the top. As a result, the central region of the top is often structurally reinforced or filled to support the continuous ring.

Illustrative embodiments provide a central recess or channel within the top surface is by using a plurality of magnetic segments 32 arranged (e.g., in an arc or partial ring configuration) rather than as a continuous annular ring. The magnetic segments 32 are positioned such that a defined central region of the top remains substantially free of magnetic material. This magnet-free region permits the formation of a top channel or recess without compromising the magnetic coupling structure.

Because in various embodiments the magnetic segments 32 do not form a complete ring, the central region can be structurally configured to define a recess 31 that extends at least partially into the thickness of the top 30. In the collapsed configuration, at least a portion of the arm 20 may be received within this top channel 31. The absence of the continuous magnet ring enables the recess 31 to occupy space that would otherwise be structurally unavailable with a full-ring.

Accordingly, in some embodiments, the segmented magnetic 32 arrangement is structurally interdependent with the recessed top channel 31. The magnet topology enables the channel 31 geometry, and the channel 31 geometry enables reception of the arm 20 in the collapsed configuration. This structural cooperation allows the arm 20 to be positioned within the thickness envelope of the top 30, thereby reducing the overall collapsed thickness of the stand 1 relative to a configuration in which the arm 20 would be stacked externally on top of the top surface 30.

In certain embodiments, a complete annular magnet ring would block or substantially limit the formation of such a central channel 31 without increasing the overall thickness of the top 30. The continuous ring occupies the available thickness envelope and reduces the ability to form a recess of sufficient depth to receive the arm 20. By contrast, the partial arc configuration leaves usable thickness region within the top 30 for mechanical nesting.

Thus, the reduced collapsed thickness achieved by the present stand 1 is not merely a matter of making the device 1 “thin.” Rather, in various embodiments, it results from a structural relationship including (i) the segmented magnets, (ii) the magnet-free central region, (iii) the formation of a top channel within that region, and/or (iv) the reception of the arm within the channel in the collapsed configuration.

In certain embodiments, the magnetic segments 32 may be arranged circumferentially around at least a portion of the perimeter of the central region. The segments may define an incomplete ring, a broken ring, multiple discrete arc segments, or other non-continuous arrangements that preserve magnetic coupling strength while leaving a region available for recess formation. Some embodiments may use a single magnetic segment 32.

In various embodiments, the coordinated configuration of magnetic topology and mechanical nesting geometry advantageously provides a thin expandable stand 1. The magnetic architecture is selected not merely for attachment strength, but to enable structural accommodation of the arm 20 within the top 30 thickness. This interdependency between magnetic configuration and recess geometry distinguishes the present design from conventional full-ring magnetic accessories in which magnet placement precludes or discourages such nesting.

FIG. 7 shows a side view the Expandable Stand 1 coupled with the Mobile Device 600 while in the expanded state. Here the Mobile Device 600 is magnetically attached with the Top 30 (e.g., because the Magnetic Segments 32 (not shown) have been aligned with the Magnetic Ring 632 (not shown) of the Mobile Device 600). The Mobile Device 600 may be held by the Top 30 primarily through magnetic force, though friction force, for example, may also help prevent the Mobile Device 600 from sliding off the Top 30. The additional friction force between the Mobile Device 600 and Top 30 may be provided by adding a layer of material with higher friction co-effient to the Top 30 or some area of the Top 30. The material may be a coating, spray, adhered material, etc. It can also be seen in FIG. 7 that the Mobile Device 600 may be suspended away from the Base 10 by the Arm 20, and that the height and angle with respect to the Base 10 may be adjusted using the Top Hinge 22 and/or the Base Hinge 21.

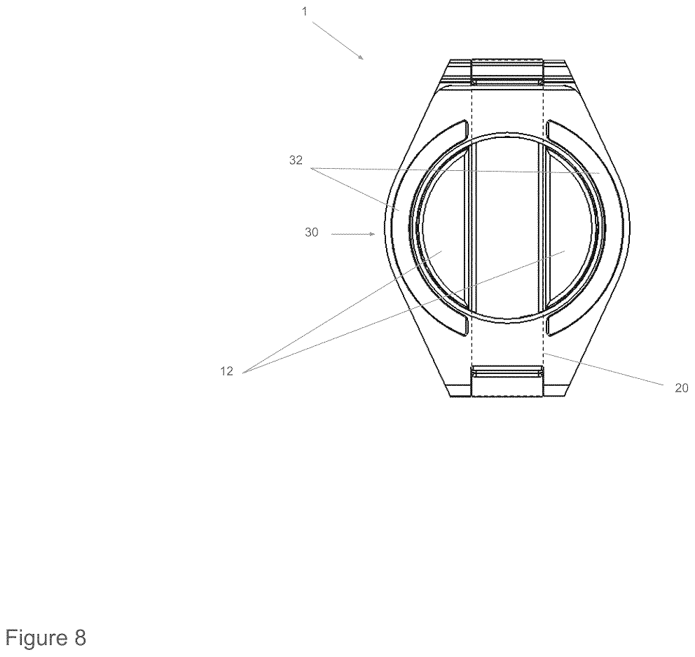

FIG. 8 shows a top view of the Expandable Stand 1 in the collapsed position. As shown, at least a portion of the Arm 20 may be integrated within the volume of the Top 30 in the collapsed position (e.g., within the magnetic segments 32). The Magnetic Segments 32 may contain magnets, and therefore, they may have a thickness greater than that of some other areas of the Top 30. By using Magnetic Segments 32 rather than an entire unbroken ring (in a manner similar to the Magnetic Ring 632) there is the opportunity to create a thinner center area of the top in which the Arm 20 is inlaid (e.g., inside of the Top Channel 31). Although a larger unbroken ring may supply even more magnetic force to the Mobile Device 6, the Magnetic Segments 32 can be sized and configured to supply adequate magnetic force in order to hold the Mobile Device 600 to the Top 30.

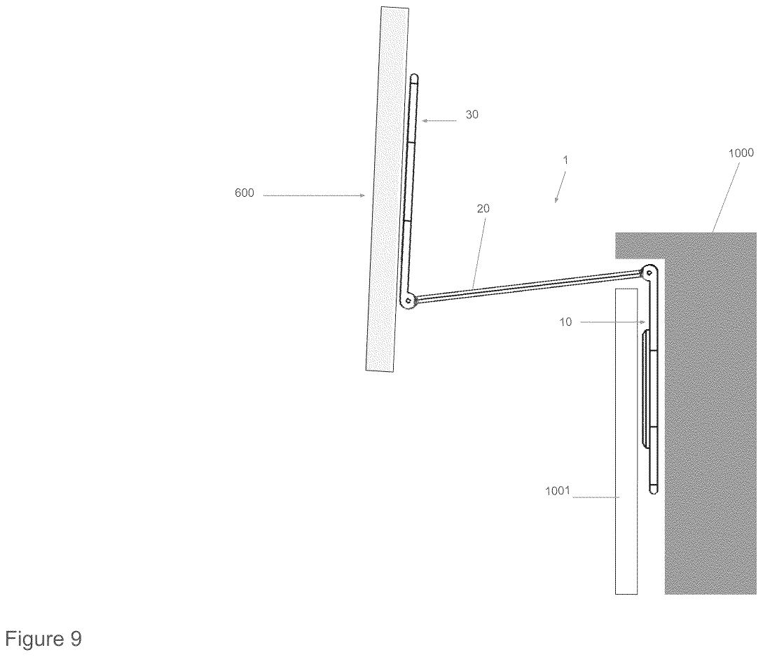

FIG. 9 schematically shows the Expandable Stand configured for use with an airplane Traytable 1001. The Base 10 may be thin enough to fit behind an airplane Traytable 1001 on the back on an airplane Seat 1000 (e.g., when they Traytable 1001 is in the stowed position). The Projected Weights 12 may be reduced and/or removed to allow the Base to fit behind the Traytable 1001. The Expandable Stand 1 advantageously provides a thin Base 10 with a thin Arm 20 that a user may mount on the back of the airplane Seat 1000. This allows the user to view their Mobile Device 600 directly in front of their seat.

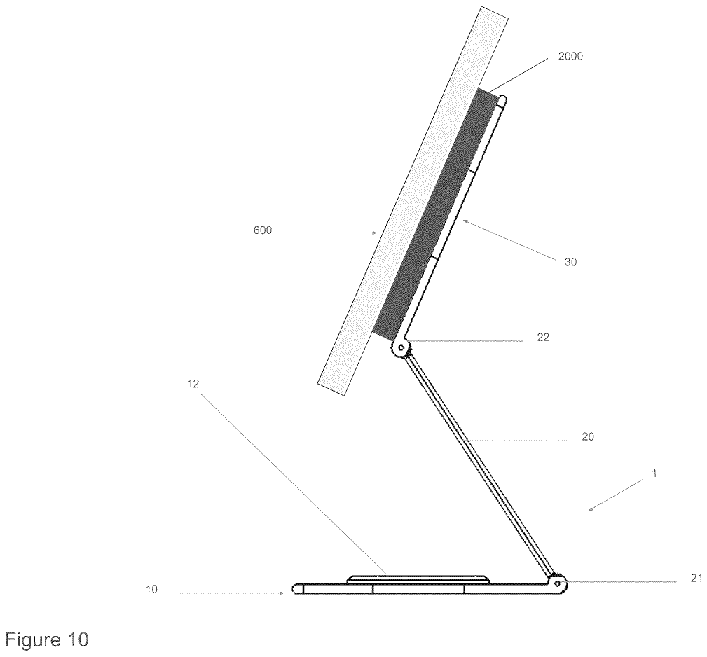

FIG. 10 shows a side view of the Expandable Stand with a charging pad 2000 on Top 30 in accordance with illustrative embodiments. The Charging Pad 2000 may be (e.g., magnetically) stuck to the Top 30 to add charging functionality to the Expandable Stand 1. The Charging Pad 2000 may be configured to couple more strongly to the Expandable Stand 1 than the Mobile Device 600, so that when the Mobile Device 600 is removed from the Stand 1, the Charging Pad 2000 remains coupled with the Expandable Stand 1. This can be accomplished, for example, by using additional magnets, thereby allowing the magnetism of the Charging Pad 2000 to pass through or by applying a ring of steel to the back of the Charging Pad 2000 such that it stays stuck to the Expandable Stand 1.

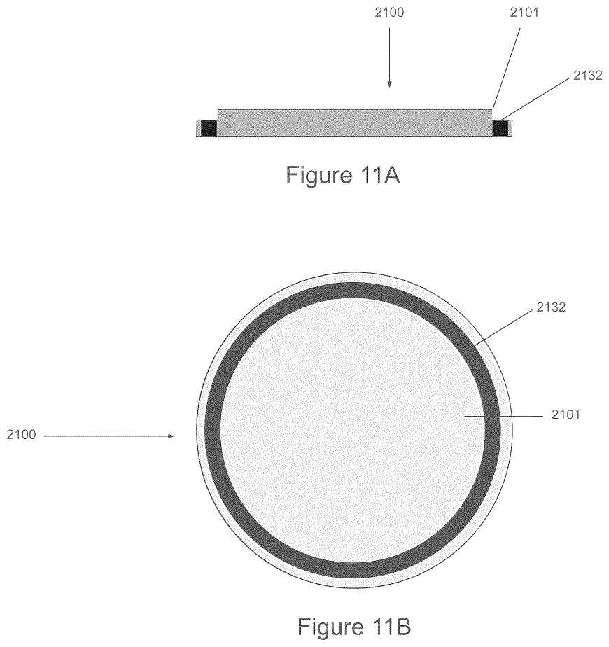

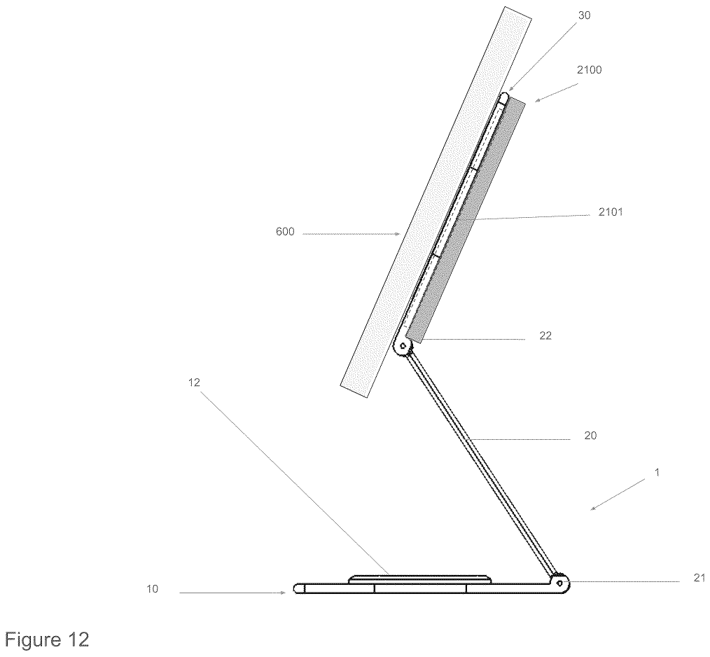

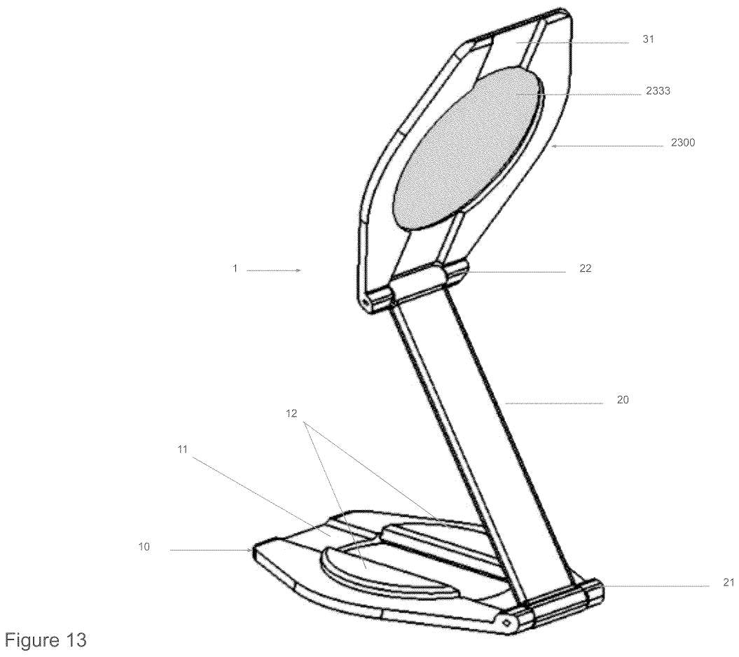

FIGS. 11A, 11B, and 12 schematically show a Shaped Charging Pad 2100 that is shaped and configured to couple with the back of the Top 30. FIGS. 11A and 11B show a partial side and top cutoff view of a Shaped Charging Pad 2100, respectively. The electrical components of the Shaped Charging Pad 2100 are not illustrated in the figures. However, it can be seen that the Shaped Charging Pad 2100 has a Protruded Section 2101 and Charger Magnets 2132. FIG. 12 shows the Shaped Charging Pad 2100 inserted into the back of the Top 30 of the Expandable Stand 1. The Protruded Section 2101 is shown as a dotted line in FIG. 12 because it is encompassed in the Passage 33 of the Top 30 section.

The Charger Magnets 2132 maintain the Shaped Charging Pad 2100 in place because they are attracted to the internal Magnetic Segments 32 of the Expandable Stand 1. In this embodiment it can be seen in FIG. 12 that the Mobile Device 600 would once again couple with the Top 30 but also be in close proximity to the Protruded Section 2101 of the Charging Pad 2100. The Protruded Section 2101 of the Shaped Charging Pad 2100 may contain a wireless charging coil (not shown) which can wirelessly charge the Mobile Device 600 (e.g., the magnetic portions are configured to align a wirelessly charging coil of the Pad 2100 with a wireless power transfer coil of the Mobile Device 600).

FIG. 13 schematically shows the Expandable Stand 1 using wireless charging in accordance with illustrative embodiments. The Expandable Stand 1 may also function as a wireless charger. Here the Charging Top 2300 is built similar to the previous Top 30 (e.g., with the Top Channel 31 integrated into the shape). However the Charging Top 2300 also includes a Charging Coil 2333 in the center. Although the Projected Weights 12 are shown in the drawing, they may need to be reduced or eliminated so as not to conflict with the Charging Coil 233 area in the collapsed configuration. As previously described, the Charging Top 2300 may include the Top Channel 31, Base Channel 11 and/or Magnet Segments 32 (not shown in the figure) in order to collapse to a minimal profile.

In various embodiments, the Projected Weights 12 add thickness and weight to the base 10 using a shape which goes around the Arm 20 (i.e. the Bottom Channel 11). Through this configuration, weight and thickness are advantageously added to the base 10 without adding thickness to the overall assembly. Some embodiments may add minimal thickness while still remaining within the scope of illustrative embodiments.

In various embodiments, the Projected Weight 12 attached to the Base 10 need not be centrally located or formed as a single upward projection. Instead, the Projected Weight 12 may be distributed across multiple regions of the Base 10 and configured to extend into one or more void regions of the Top 30 when the Expandable Stand 1 is in the collapsed configuration. For example, the Projected Weight 12 may be annular and extend around a central opening of the Top 30, or may comprise multiple discrete weight segments spaced circumferentially around the Arm 20. In other embodiments, the Projected Weight 12 may be positioned adjacent to a perimeter region of the Base 10 and extend into corresponding recesses or openings defined by the Top 30. The Projected Weight 12 may extend into multiple smaller openings rather than a single central opening, and may be symmetric or asymmetric relative to the Arm 20. In each such embodiment, the Projected Weight 12 remains attached to the Base 10 and is configured to occupy otherwise unused interior volume of the Top 30 in the collapsed configuration, thereby increasing the effective mass of the Base 10 and enhancing stability in the expanded configuration without increasing the overall collapsed thickness of the Expandable Stand 1.

In further embodiments, the Projected Weight 12 attached to the Base 10 may be removable, adjustable, or repositionable. The Projected Weight 12 may be magnetically attachable to the Base 10, mechanically secured using fasteners or clips, or slidably received within a cavity defined by the Base 10. In certain embodiments, the Projected Weight 12 may be movable between different positions within the Base 10, including a first position in which at least a portion of the Projected Weight 12 extends into interior volume of the Top 30 in the collapsed configuration and a second position in which the Projected Weight 12 is retained entirely within the Base 10. The Projected Weight 12 may also be replaceable with weights of different densities or sizes to vary the total mass of the Expandable Stand 1. In some embodiments, the Projected Weight 12 may automatically shift position when the Expandable Stand 1 transitions between the collapsed configuration and the expanded configuration. In all such variations, the Projected Weight 12 remains configured to enhance stability of the Expandable Stand 1 while preserving a low-profile collapsed configuration.

As used throughout this description, unless explicitly stated otherwise, any feature, structure, step, or function described in connection with one embodiment may be used independently of that embodiment and may be combined with any feature, structure, step, or function described in connection with any other embodiment, in any technically feasible combination. References to components or embodiments as alternatives are for illustrative purposes only and do not imply that such components or embodiments are mutually exclusive, unless explicitly stated. The described embodiments are illustrative only and are not intended to limit the scope of the invention to the specific combinations shown.

Any feature, structure, step, or functional relationship that is described only once or in connection with a single embodiment is nevertheless intended to be generally applicable throughout this description, unless explicitly stated otherwise. Such features may be implemented independently of the particular embodiment in which they are described and may be combined with any other features described herein, in any technically feasible manner.

For example, it can be seen in FIG. 8 taken in conjunction with other figures that the use of the Projected Weights 12, Magnetic Segments 32 and the Top Channel 31 and Base Channel 11 create a stable stand for a Mobile Device 600 while also minimizing the overall thickness of the Expanded Stand 1 configuration in the collapsed position.

It can further be seen in by taking FIG. 2 in conjunction with FIG. 9 that by reducing or removing the Projected Weights 12 that the base could be made so thin so that it may be placed behind a Tray Table 1001 thereby suspending the Expandable Stand 1 behind an Airplane Seat 1000. Illustrative embodiments advantageously provide a thin Base 10 because the Base Channel 11 allows the Base Hinge 21 to be in same plane as the Base 10 as the Arm 20 can rest inside the Base Channel 11.

The Expanded Stand 1 may be formed from any rigid or semi-rigid material such as metal, plastic, rubber, wood, etc. All of the same principles apply regardless of material although for weight, durability and rigidity a metal such as zinc, steel or aluminum may be optimal. The Expanded Stand 1 may also be formed from a mix of materials, such as plastic for a majority of the construction, and metal used as projected weights and magnets.

The Magnetic Segments 32 may be magnets polarized to be attracted to MagSafe and Qi2 style mobile devices or cases. Or the Magnetic Segments 32 may be simply ferromagnetic material, such as steel. The Magnetic Segments 32 may be composed of smaller material (e.g. smaller magnets or steel inserts) and glued or otherwise adhered into the Top 30.

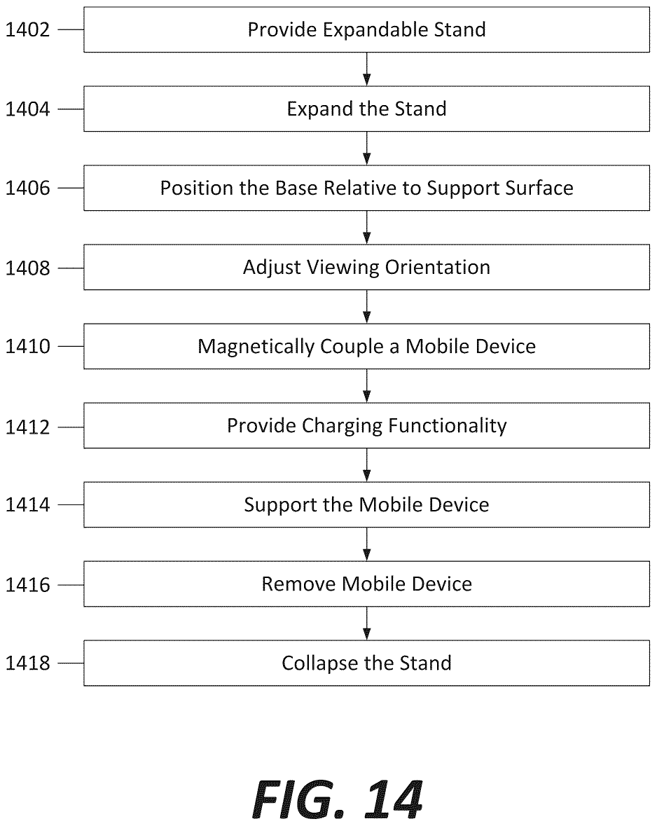

FIG. 14 shows a process of using the Expandable Stand 1 in accordance with illustrative embodiments. It should be noted that this method is substantially simplified from a longer process that may normally be used. Accordingly, the method shown in FIG. 14 may have many other steps that those skilled in the art likely would use. In addition, some of the steps may be performed in a different order than that shown, or at the same time. For example, step 1410 may come before step 1408. Furthermore, some of these steps may be optional in some embodiments (e.g., providing charging functionality). Accordingly, the process 1400 is merely exemplary of one process in accordance with illustrative embodiments. Those skilled in the art therefore can modify the process as appropriate.

The process begins at Step 1402, which provides the Expandable Stand 1 in a collapsed configuration. In the collapsed configuration, the Arm 20 is positioned between the Base 10 and the Top 30 such that at least a portion of the Arm 20 is received within the Base Channel 11 and/or the Top Channel 31. The Top 30 is positioned adjacent to the Base 10, and the overall thickness of the Expandable Stand 1 is minimized. In this configuration, the Arm 20 is substantially contained within the combined thickness defined by the Base 10 and the Top 30. Additionally, the Projected Weight 12 attached to the Base 10 may extend into an interior region of the Top 30 in the collapsed configuration without increasing the overall external thickness of the Expandable Stand 1. The Expandable Stand 1 in this state is compact and suitable for transport, storage, or placement in a pocket, bag, or other carrying compartment prior to transition to an expanded configuration.

In certain embodiments, the collapsed configuration of the Expandable Stand 1 is not limited to a purely vertical stacking relationship between the Base 10 and the Top 30. While the figures show the Top 30 generally positioned above the Base 10 in the collapsed configuration, it is contemplated that the Base 10 and the Top 30 may overlap in vertical and/or planar directions. In such embodiments, the Top 30 may be laterally offset relative to the Base 10 when the Arm 20 is received within the Base Channel 11 and/or the Top Channel 31. The collapsed configuration may therefore include both vertical nesting and lateral overlap while still maintaining a minimized overall thickness.

In some embodiments, the geometry of the Base Hinge 21 and the Top Hinge 22 may cause the Top 30 to shift forward, rearward, or sideways relative to the Base 10 as the Arm 20 transitions into the collapsed configuration. This lateral displacement may result in portions of the Top 30 extending beyond a perimeter of the Base 10 or partially overlapping the footprint of the Base 10 in a non-coaxial arrangement. Such lateral overlap may permit additional volumetric interleaving between components, including partial reception of the Projected Weight 12 within an interior region of the Top 30, without increasing the overall collapsed thickness of the Expandable Stand 1.

In further embodiments, the Arm 20 may include an offset, articulated, or telescoping structure that permits the Top 30 to move laterally relative to the Base 10 during collapse. For example, the Arm 20 may guide the Top 30 into a position in which portions of the Top 30 interleave with recesses or cutout regions of the Base 10. The Base 10 and the Top 30 may therefore partially overlap in a planar direction while still maintaining the functional relationship in which the Arm 20 is received within internal volume defined by the Base 10 and the Top 30. In such embodiments, the collapsed configuration remains defined by reduced overall thickness and compactness, rather than by strict vertical alignment between the Base 10 and the Top 30.

Accordingly, the collapsed configuration of the Expandable Stand 1 may include vertical nesting, planar overlap, interleaving, offset alignment, or combinations thereof, so long as the Arm 20 is received within the stand and the overall thickness of the Expandable Stand 1 is minimized for storage or transport.

At step 1404, the Expandable Stand 1 transitions from the collapsed configuration to an expanded configuration by moving the Arm 20 relative to the Base 10 and the Top 30. In particular, the Arm 20 is pivoted about the Base Hinge 21 relative to the Base 10 and pivoted about the Top Hinge 22 relative to the Top 30. This movement causes the Top 30 to separate from the Base 10, such that the Top 30 is spaced apart from the Base 10. As the Arm 20 pivots outward from the Base Channel 11 and the Top Channel 31, the Arm 20 exits the nested position within the Base 10 and the Top 30. In the expanded configuration, the Arm 20 extends between the Base 10 and the Top 30 to define a support structure capable of elevating and orienting a Mobile Device 600. The Base Hinge 21 and the Top Hinge 22 may provide frictional resistance or other position-retention forces such that the Expandable Stand 1 remains in the expanded configuration without requiring additional locking components.

At Step 1406, the Base 10 is positioned relative to a support structure to prepare the Expandable Stand 1 for supporting the Mobile Device 600. In various embodiments, this step includes placing the Base 10 on a generally horizontal support surface such that a lower surface of the Base 10 contacts the support surface and provides a stable foundation. In this position, the Projected Weight 12 attached to the Base 10 contributes to lowering the center of gravity of the Expandable Stand 1 and enhancing stability in the expanded configuration.

In alternative embodiments, Step 1406 includes positioning the Base 10 relative to a non-horizontal support structure. For example, the Base 10 may be inserted between a Tray Table 1001 and an Airplane Seat 1000 such that the Base 10 is retained between the Tray Table 1001 and the Airplane Seat 1000. In such embodiments, the Expandable Stand 1 may be supported in a generally vertical orientation while the Arm 20 extends outward to position the Top 30 for viewing. Regardless of the particular support structure used, Step 1406 establishes a stable positional relationship between the Base 10 and the surrounding environment prior to magnetically coupling the Mobile Device 600 to the Top 30.

Step 1408 includes adjusting a relative orientation between the Base 10 and the Top 30 to position the Expandable Stand 1 for viewing of a Mobile Device 600. This adjustment is accomplished by pivoting the Arm 20 relative to the Base 10 about the Base Hinge 21 and/or pivoting the Arm 20 relative to the Top 30 about the Top Hinge 22. By selectively rotating the Arm 20 about one or both of the Base Hinge 21 and the Top Hinge 22, the Top 30 may be raised, lowered, tilted, or otherwise oriented to achieve a desired viewing angle. In embodiments in which the Base Hinge 21 and the Top Hinge 22 include frictional resistance or other position-retention mechanisms, the Expandable Stand 1 maintains the selected orientation without requiring additional locking components. Step 1408 may be performed before or after magnetically coupling the Mobile Device 600 to the Top 30, and may be repeated as needed to refine the viewing position while the Expandable Stand 1 remains in the expanded configuration.

Step 1410 magnetically couples a Mobile Device 600 to the Top 30 of the Expandable Stand 1. In this step, the Mobile Device 600 is positioned adjacent to the Top 30 such that a Magnetic Ring 632 associated with the Mobile Device 600 is aligned with Magnetic Segments 32 disposed within the Top 30. As the Mobile Device 600 is brought into proximity with the Top 30, magnetic attraction between the Magnetic Ring 632 and the Magnetic Segments 32 causes the Mobile Device 600 to magnetically couple to the Top 30. In certain embodiments, the Magnetic Segments 32 are arranged circumferentially around a central region of the Top 30 to facilitate alignment with the Magnetic Ring 632 and to provide a secure magnetic attachment. Friction between the Mobile Device 600 and a surface of the Top 30 may further resist sliding movement after magnetic coupling. Once magnetically coupled, the Mobile Device 600 is retained on the Top 30 in the expanded configuration for viewing and use.

Step 1412 provides charging functionality to the Mobile Device 600 while the Mobile Device 600 is supported on the Top 30 of the Expandable Stand 1. In various embodiments, this step includes magnetically coupling a Charging Pad 2000 to the Top 30 such that the Charging Pad 2000 is retained against the Top 30 by magnetic attraction. A charging coil within the Charging Pad 2000 may then be electrically energized to wirelessly transmit power to the Mobile Device 600 while the Mobile Device 600 remains magnetically coupled to the Top 30.

In some embodiments, Step 1412 includes inserting a Protruded Section 2101 of a Shaped Charging Pad 2100 into an opening defined by the Top 30. The Shaped Charging Pad 2100 may be magnetically retained relative to the Top 30 by Charger Magnets 2132 attracted to Magnetic Segments 32 disposed within the Top 30. In this configuration, a charging coil contained within the Shaped Charging Pad 2100 is positioned in proximity to the Mobile Device 600 to enable wireless charging.

In further embodiments, Step 1412 includes energizing a Charging Coil 2333 integrated within a Charging Top 2300 forming part of the Expandable Stand 1. In such embodiments, the Charging Coil 2333 is disposed within the Top 30 and is configured to wirelessly charge the Mobile Device 600 when electrically powered. Regardless of the particular charging configuration employed, Step 1412 provides electrical energy to the Mobile Device 600 while the Mobile Device 600 remains supported by the Expandable Stand 1 in the expanded configuration.

Step 1414 supports the Mobile Device 600 on the Top 30 of the Expandable Stand 1 while the Expandable Stand 1 is in the expanded configuration. In this state, the Arm 20 extends between the Base 10 and the Top 30, maintaining the Top 30 in a spaced relationship relative to the Base 10. The Mobile Device 600 remains magnetically coupled to the Top 30 through interaction between the Magnetic Ring 632 of the Mobile Device 600 and the Magnetic Segments 32 disposed within the Top 30. The Base 10 engages the support structure, and the Projected Weight 12 attached to the Base 10 contributes to lowering the center of gravity of the Expandable Stand 1, thereby enhancing resistance to tipping. In various embodiments incorporating charging functionality, the Mobile Device 600 may simultaneously receive electrical energy while being supported. During Step 1414, the Expandable Stand 1 maintains the selected viewing orientation established in Step 1408, allowing the Mobile Device 600 to be viewed or operated without manual support by a user.

Step 1416 uncouples the Mobile Device 600 from the Top 30 of the Expandable Stand 1. In this step, a separating force is applied to the Mobile Device 600 sufficient to overcome magnetic attraction between the Magnetic Ring 632 of the Mobile Device 600 and the Magnetic Segments 32 disposed within the Top 30. As the Mobile Device 600 is moved away from the Top 30, magnetic coupling is released and the Mobile Device 600 is disengaged from the Expandable Stand 1. In various embodiments in which charging functionality is provided, removal of the Mobile Device 600 may simultaneously terminate wireless charging between the Mobile Device 600 and a Charging Pad 2000, a Shaped Charging Pad 2100, or a Charging Coil 2333 integrated within a Charging Top 2300. Following Step 1416, the Expandable Stand 1 remains in the expanded configuration and may subsequently be transitioned to the collapsed configuration for storage or transport.

Step 1418 transitioning the Expandable Stand 1 from the expanded configuration back to the collapsed configuration. In this step, the Arm 20 is pivoted relative to the Base 10 about the Base Hinge 21 and pivoted relative to the Top 30 about the Top Hinge 22 such that the Top 30 moves toward the Base 10. As the Arm 20 rotates, at least a portion of the Arm 20 is received within the Base Channel 11 and/or the Top Channel 31. The Top 30 is positioned adjacent to the Base 10 such that the overall thickness of the Expandable Stand 1 is minimized. In embodiments including a Projected Weight 12 attached to the Base 10, the Projected Weight 12 may extend into an interior region of the Top 30 in the collapsed configuration without increasing the external thickness of the Expandable Stand 1. Upon completion of Step 1418, the Expandable Stand 1 is returned to a compact state suitable for storage, transport, or placement in a pocket, bag, or other carrying compartment. The process then comes to an end.

One skilled in the art will realize the embodiments described herein may be embodied in other specific forms without departing from the spirit or essential characteristics thereof. The foregoing embodiments are therefore to be considered in all respects illustrative rather than limiting of the embodiments described herein.

References to components or embodiments as alternatives are for illustrative purposes only and do not imply that such components or embodiments are mutually exclusive, unless explicitly stated.

As used in this specification and the claims, the singular forms “a,” “an,” and “the” refer to plural referents unless the context clearly dictates otherwise. For example, reference to “the arm” in the singular includes a plurality of arms, and reference to “the top” in the singular includes one or more filters and equivalents known to those skilled in the art. Thus, in various embodiments, any reference to the singular includes a plurality, and any reference to more than one component can include the singular.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein.

It is, therefore, to be understood that the foregoing embodiments are presented by way of example only and that, within the scope of the appended claims and equivalents thereto, inventive embodiments may be practiced otherwise than as specifically described and claimed. Illustrative embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure. Disclosed embodiments, or portions thereof, may be combined in ways not listed above and/or not explicitly claimed. Thus, one or more features from variously disclosed examples and embodiments may be combined in various ways. For example, it is to be understood that the present disclosure contemplates that, to the extent possible, one or more features of any embodiment can be combined with one or more features of any other embodiment.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Although the above discussion discloses various exemplary embodiments of the invention, it should be apparent that those skilled in the art can make various modifications that will achieve some of the advantages of the invention without departing from the true scope of the invention.

1-46. (canceled)

47. A collapsible magnetic stand for supporting a mobile device, comprising:
a base;
a top configured to magnetically couple to a mobile device;
an arm extending between the base and the top, the arm being movable between an expanded configuration and a collapsed configuration;
wherein the top includes a recess extending into a thickness of the top, and
the top includes a plurality of magnetic segments arranged in a non-continuous configuration, the non-continuous configuration of magnetic segments defining a magnet-free region within the top corresponding to the recess; and
wherein, in the collapsed configuration, at least a portion of the arm is received within the recess such that the arm is positioned within a thickness envelope of the top.

48. The collapsible magnetic stand of claim 47, wherein, in the collapsed configuration, an overall thickness of the stand is less than a sum of a base thickness, an arm thickness, and a top thickness measured independently.

49. The stand of claim 47, wherein the magnetic segments are arranged along an arc that spans less than 360 degrees around the recess.

50. The stand of claim 47, wherein the recess is centrally located relative to the magnetic segments.

51. The stand of claim 47, wherein the magnetic segments are configured to at least partially align with a MagSafe or Qi2 magnetic attachment structure.

52. The stand of claim 47, wherein the magnetic segments are positioned around at least a portion of the recess.

53. The stand of claim 47, wherein the magnetic segments are separated by gaps.

54. The stand of claim 47, wherein the magnetic segments are arranged such that the recess is located within a region of the top free of magnetic material.

55. The stand of claim 47, wherein the recess extends into the region of the top that is free of magnetic material.

56. The stand of claim 47, wherein the recess is slot-shaped, linear, arcuate, rectangular, polygonal, or non-circular.

57. The stand of claim 47, the recess extends into at least 25% of the thickness of the top.

58. The stand of claim 47, wherein the recess has a depth at least equal to an arm thickness.

59. The stand of claim 47, wherein the recess is positioned such that the arm is aligned with the recess along a thickness axis in the collapsed configuration.

60. The stand of claim 47, wherein an overall thickness of the stand in the collapsed configuration is less than a sum of a base thickness, an arm thickness, and a top thickness measured independently.

61. A collapsible mobile device stand comprising:
a base;
a top configured to support a mobile device;
an arm structure extending between the base and the top and movable between an expanded configuration and a collapsed configuration;
wherein, in the collapsed configuration, at least a portion of the arm structure is received within an internal channel defined by at least one of the base or the top; and
wherein the stand has a maximum device thickness in the collapsed configuration that is less than a sum of a base thickness, an arm thickness, and a top thickness measured independently.

62. The stand of claim 61, wherein the maximum device thickness in the collapsed configuration is defined by the greater of:
(i) a combined overlapping thickness of the base, the arm structure, and the top; or
(ii) a maximum external thickness defined by a hinge or other protruding structural element of the stand.

63. The stand of claim 61, wherein the base thickness includes thickness contributed by a weight coupled to or embedded within the base.

64. The stand of claim 63, wherein the weight is integrated within an external thickness envelope of the base in the collapsed configuration.

65. The stand of claim 61, wherein the top thickness includes thickness contributed by one or more magnetic elements embedded within, attached to, or overmolded by the top.

66. The stand of claim 61, wherein the top thickness includes thickness contributed by a wireless charging coil positioned within the top.

67. The stand of claim 61, wherein the base thickness includes thickness contributed by an electrical component positioned within the base.

68. The stand of claim 61, wherein the arm thickness includes thickness contributed by an internal electrical conductor, structural reinforcement, or hinge interface.

69. The stand of claim 61, wherein at least one of the base or the top includes an overmolded layer, coating, or surface treatment that contributes to the respective component thickness.

70. The stand of claim 61, wherein at least one of the base or the top includes an adhesive layer, pad, or attachment structure that contributes to the respective thickness.
